(19) United States
(12) Patent Application Publication
(10) Pub. No.: US 2015/0156482 A1
(43) Pub. Date: Jun. 4, 2015

(54) THREE-DIMENSIONAL (3D) LIQUID CRYSTAL DISPLAY (LCD) DEVICE, 3D LCD DISPLAY SYSTEM AND 3D IMAGE DISPLAY DRIVING METHOD

(71) Applicants: BEIJING BOE DISPLAY TECHNOLOGY CO., LTD., Beijing (CN); BOE TECHNOLOGY GROUP CO., LTD., Beijing (CN)

(72) Inventors: Zhihua Sun, Beijing (CN); Liang Zhang, Beijing (CN); Yizhen Xu, Beijing (CN); Baoyu Liu, Beijing (CN)

(21) Appl. No.: 14/348,688

(22) PCT Filed: Dec. 11, 2013
(86) PCT No.: PCT/CN2013/089146

§ 371 Date: Mar. 31, 2014

(30) Foreign Application Priority Data
May 31, 2013 (CN) 201310211767.4

(51) Int. Cl. H04N 13/04; G09G 3/36

(52) U.S. Cl. CPC H04N 13/0438; G09G 3/3685; H04N 13/0497; G09G 3/3607; G09G 3/3674; H04N 13/0422; G09G 2300/0408; G09G 2300/0404; G09G 2300/0426; G09G 2310/08; G09G 2320/0666; G09G 2320/0209; G09G 2310/027

(57) ABSTRACT

A three-dimensional (3D) liquid crystal display (LCD) device, a 3D LCD system and a 3D image display driving method are disclosed. The 3D LCD device includes a display panel and a timing controller. The display panel includes an array substrate; the array substrate includes a plurality of pixel units defined by gate lines and data ones which are horizontally and vertically intersected; a plurality of the pixel units include left-eye pixels configured to display a left-eye image and right-eye pixels configured to display a right-eye image; and the timing controller is connected with the array substrate and configured to respectively control the display timing of the left-eye pixels and the right-eye pixels. The 3D LCD device can achieve the objective of reducing the crosstalk when applied to active shutter 3D LCD.

### TECHNICAL FIELD

Embodiments of the present invention relate to a three-dimensional (3D) liquid crystal display (LCD) device, a 3D LCD system, and a 3D image display driving method.

### BACKGROUND

With the continuous development of display technologies, people begin to pursue a more realistic display experience. In response to this trend, 3D technology emerges. 3D technology can be substantially divided into glasses-free 3D technology and glasses 3D technology (3D technology with glasses). Due to the constraints of skill levels, costs and the like, the glasses-free 3D technology has not become popular. Currently, the products in the market mainly comply with the glasses 3D technology. The glasses 3D technology mainly includes anaglyph type, polarization type and active shutter type. The active shutter 3D display technology has increasingly become the mainstream of the 3D display market due to its good display effect. The shutter glasses 3D display technology has increasingly become the mainstream of the 3D market, but the crosstalk problem is always a bottleneck for realizing better 3D display effect.

The shutter glass 3D display increases the refresh rate of a display screen to output images to be respectively watched by a left eye and a right eye at intervals in a time-sharing way, and further coordinates the image display of the display screen and the switching of a pair of shutter glasses to allow a left-eye lens to be switched on and a right-eye lens to be switched off when a left-eye image is displayed by the display screen and allow the right-eye lens to be switched on and the left-eye lens to be switched off when a right-eye image is displayed by the display screen. However, as liquid crystals in an LCD have slow response speed, the response speed of the image cannot keep up with the refresh speed of the glasses. Thus, for instance, as for an H-shaped pattern as illustrated in FIG. 1, in the viewing process, the left eye of a viewer may watch an image (3D-L frame) which should be viewed by the right eye, and the right eye may watch an image (3D-R frame) which should be viewed by the left eye. In this case, the viewer can watch a transverse ghost of the image through the shutter glasses.

A scanning backlight can partially reduce crosstalk, but there will be light diffusion between the regions of the scanning backlight. A scanning backlight is expected to evade the dynamic response time of liquid crystals by turning off the backlight, but the crosstalk of adjacent backlight regions allows the viewer to view the contents which are not expected.

240 Hz black frame insertion (BFI) method can also partially reduce crosstalk in the 3D display. The increase of the refresh rate place strict requirements on the response time of liquid crystals. When the refresh rate is higher, the charge time is shorter, and hence the charge rate will be insufficient within the limited charge time.

### SUMMARY

Embodiments of the present invention provides a 3D LCD device, a 3D LCD system and a 3D image display driving method, which are used for effectively solving the problem of crosstalk in the 3D display.

An aspect of the present invention provides a 3D LCD device, which comprises a display panel and a timing controller. The display panel includes an array substrate; the array substrate includes a plurality of pixel units defined by gate lines and data lines which are horizontally and vertically intersected; a plurality of the pixel units include left-eye pixels configured to display a left-eye image and right-eye pixels configured to display a right-eye image; and the timing controller is connected with the array substrate and configured to respectively control the display timing of the left-eye pixels and the right-eye pixels.

For instance, the 3D LCD device may further comprise a driving unit. The timing controller is respectively connected with the left-eye pixels and the right-eye pixels on the array substrate through the driving unit.

For instance, in the 3D LCD device, both the left-eye pixels and the right-eye pixels are arranged in columns; left-eye pixel columns and right-eye pixel columns are alternately arranged; the driving unit includes a data driving unit; and the timing controller is respectively connected with the data lines, corresponding to the left-eye pixel columns and the right-eye pixel columns on the array substrate, through the data driving unit, and configured to respectively control the display timing of the left-eye pixels and the right-eye pixels.

For instance, in the 3D LCD device, the left-eye pixels include a plurality of columns of left-eye sub-pixels, and the right-eye pixels include a plurality of columns of right-eye sub-pixels; the left-eye sub-pixels and the right-eye sub-pixels are alternately arranged; the driving unit includes a data driving unit; and the timing controller is respectively connected with data lines, corresponding to the left-eye sub-pixels and the right-eye sub-pixels on the array substrate, through the data driving unit, and configured to respectively control the display timing of the left-eye sub-pixels and the right-eye sub-pixels.

For instance, in the 3D LCD device, a sub-pixel group is formed by one column of the left-eye sub-pixels and one column of the right-eye sub-pixels, which columns are adjacent to each other; and color filters corresponding to the left-eye sub-pixels and the right-eye sub-pixels in the same sub-pixel group have different colors, or the color filters corresponding to the left-eye sub-pixels and the right-eye sub-pixels in the same sub-pixel group have same color, and color filters corresponding to two adjacent sub-pixel groups have different colors.

For instance, in the 3D LCD device, both the left-eye pixels and the right-eye pixels are arranged in rows; left-eye pixel rows and right-eye pixel rows are alternately arranged; the driving unit includes a gate electrode driving unit; and the timing controller is respectively connected with gate lines, corresponding to the left-eye pixel rows and the right-eye pixel rows on the array substrate, through the gate electrode driving unit, and configured to respectively control the display timing of the left-eye pixels and the right-eye pixels.

For instance, in the 3D LCD device, the left-eye pixels include a plurality of rows of left-eye sub-pixels, and the right-eye pixels include a plurality of rows of right-eye sub-pixels; the driving unit includes a gate electrode driving unit; the left-eye sub-pixels and the right-eye sub-pixels are alternately arranged; and the timing controller is respectively connected with gate lines, corresponding to the left-eye sub-pixels and the right-eye sub-pixels on the array substrate, through the gate electrode driving unit, and configured to respectively control the display timing of the left-eye sub-pixels and the right-eye sub-pixels.

For instance, in the 3D LCD device, a sub-pixel group is formed by one row of the left-eye sub-pixels and one row of the right-eye sub-pixels, which rows are adjacent to each other; and color filters corresponding to the left-eye sub-pixels and the right-eye sub-pixels in the same sub-pixel group have different colors, or the color filters corresponding to the left-eye sub-pixels and the right-eye sub-pixels in the same sub-pixel group have same color, and color filters corresponding to two adjacent sub-pixel groups have different colors.

In another aspect, the present invention provides a 3D LCD system, which comprises any foregoing 3D LCD device and a pair of 3D glasses.

In still another aspect, the present invention provides a driving method for achieving 3D image display by adoption of the 3D LCD system. The driving method comprises: performing BFI with respect to right-eye pixels of the LCD device and meanwhile controlling a left-eye lens of the 3D glasses to be switched on and a right-eye lens to be switched off, when a left-eye image is displayed by left-eye pixels of the LCD device; and performing BFI with respect to the left-eye pixels of the LCD device and meanwhile controlling the right-eye lens of the 3D glasses to be switched on and the left-eye lens to be switched off, when a right-eye image is displayed by the right-eye pixels of the LCD device.

### BRIEF DESCRIPTION OF THE DRAWINGS

Simple description will be given below to the accompanying drawings of the embodiments to provide a more clear understanding of the technical proposals of the embodiments of the present invention. It will be obvious to those skilled in the art that the drawings described below only involve some embodiments of the present invention but are not intended to limit the present invention.

FIG. 1 is a schematic diagram illustrating the crosstalk generation mechanism of the traditional active shutter 3D display;

FIGS. 2A and 2B are block diagrams of a 3D LCD device provided by an embodiment of the present invention;

FIG. 3 is a schematic structural view of a first display panel provided by an embodiment of the present invention;

FIG. 4 is a schematic structural view of a second display panel provided by an embodiment of the present invention;

FIG. 5 is a schematic structural view of a third display panel provided by an embodiment of the present invention;

FIG. 6 is a schematic structural view of a fourth display panel provided by an embodiment of the present invention;

FIG. 7 is a schematic diagram illustrating the display of a left-eye image in the display panel provided by an embodiment of the present invention;

FIG. 8 is a schematic diagram illustrating the display of a right-eye image in the display panel provided by an embodiment of the present invention; and

FIG. 9 is a schematic diagram of a 3D LCD system provided by the present invention.

### REFERENCE NUMERALS

1. Timing Controller; 11. Single chip microcomputer; 12. Printed Circuit Board (PCB); 2. Display Panel; 3. Left-eye Pixel; 31. Left-eye Sub-pixel; 4. Right-eye Pixel; 41. Right-eye Sub-pixel; 5. Circuit Channel; 6. Data Line; 7. Gate Line.

### DETAILED DESCRIPTION

For more clear understanding of the objectives, technical proposals and advantages of the embodiments of the present invention, clear and complete description will be given below to the technical proposals of the embodiments of the present invention with reference to the accompanying drawings of the embodiments of the present invention. It will be obvious to those skilled in the art that the preferred embodiments are only partial embodiments of the present invention but not all the embodiments. All the other embodiments obtained by those skilled in the art without creative efforts on the basis of the embodiments of the present invention illustrated shall fall within the scope of protection of the present invention.

Unless otherwise defined, the technical terms or scientific terms used herein have normal meanings understood by those skilled in the art. The words “connection”, “connected” and the like are not limited to physical or mechanical connection but may include electrical connection, either directly or indirectly. The words “on”, “under”, “left”, “right” and the like only indicate the relative position relationship which is correspondingly changed when the absolute position of a described object is changed.

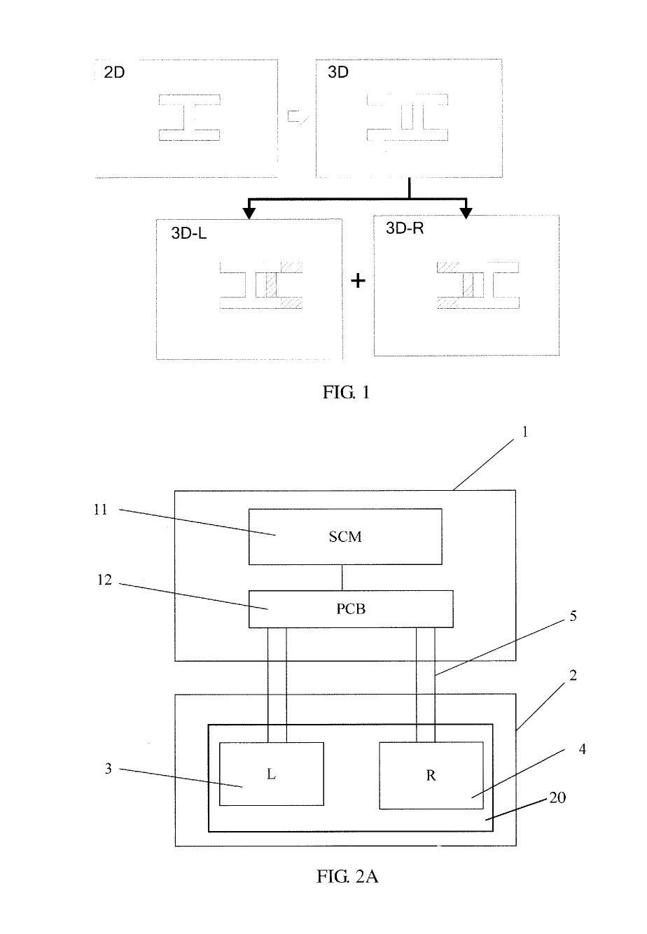

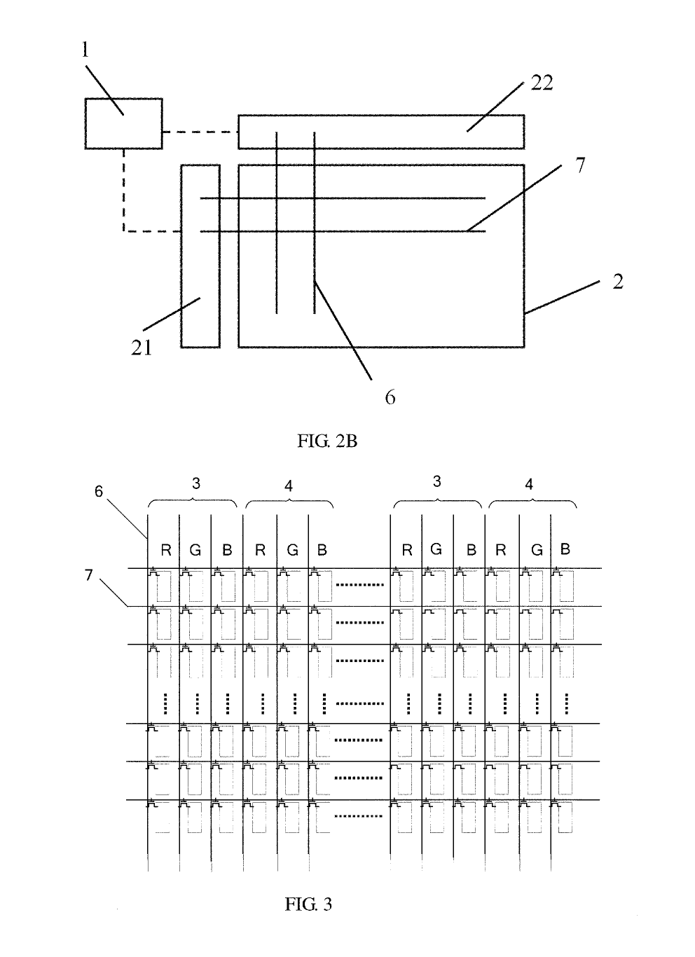

As illustrated in FIG. 2A, an embodiment of the present invention provides a 3D LCD device in the field of active shutter 3D display. The device comprises a display panel 2 and a timing controller 1. The display panel 2 includes an array substrate 20. The array substrate 20 includes a plurality of pixel units defined by gate lines 7 and data lines 6 which are horizontally and vertically intersected. A plurality of the pixel units include left-eye pixels 3 configured to display a left-eye image and right-eye pixels 4 configured to display a right-eye image, namely in display the left-eye image is integrally formed by the left-eye pixels 3 and the right-eye image is integrally formed by the right-eye pixels 4. The pixels may be pixels of three primary colors, for instance, including red, green and blue (R/G/B) sub-pixels, may also be pixels of four primary colors, for instance, including red, green, blue and yellow (R/G/B/Y) sub-pixels, and may also be pixels of another type. No limitation will be given to the specific type of the pixels. Further description will be given below to the embodiment with the pixels of three primary colors as an example. The display panel 2 further comprises an opposing substrate (not shown) which is arranged opposite to the array substrate 20, and the opposing substrate and the array substrate are combined to form a liquid crystal cell. The opposing substrate is, for instance, a color filter substrate which includes color filter sub-pixel units corresponding to the sub-pixels of the array substrate. For instance, where the pixels on the array substrate includes red, green and blue (R/G/B) trichromatic sub-pixels, the color filter substrate also includes red, green and blue color filter sub-pixel units at corresponding positions.

More specifically, as illustrated in FIG. 2B, the 3D LCD device comprises a display panel 2, a timing controller 1 and a driving unit. The driving unit includes a gate electrode driving unit 21 configured to provide gate electrode driving signals for the gate lines 7 of the display panel 2, and a data driving unit 22 configured to provide data driving signals for the data lines 6 of the display panel 2. At least one of the gate electrode driving unit 21 and the data driving unit 22 is connected with the timing controller 1 as required, and drives the display panel to achieve the display function according to the requirements of the timing controller 1.

For instance, the gate electrode driving unit 21 applies the gate electrode driving signals to switch on gate electrodes of thin-film transistors (TNI'), functioning as switching elements, of each row of pixels, in the progressive or interlaced driving manner; and the data driving unit 22 converts received display signals into voltage signals for liquid crystals to drive each pixel correspondingly, and for instance, outputs the voltage signals to the source electrodes of the TFTs of corresponding pixels. The data driving unit 22 is, for instance, connected with a data source, and this data source provides 3D display signals including left-eye image signals and right-eye image signals. For instance, the timing controller 1 may also be used as the data source; or the display device may further comprise a signal receiving unit which is used as the data source and configured to receive display data from the outside.

The timing controller 1 is connected with the array substrate 20 of the display panel 2 and configured to control the display timing of the left-eye pixels 3 and the right-eye pixels 4. For instance, the time-sharing and partition display of the left-eye image and the right-eye image can be achieved with the interlaced display of the left-eye pixels 3 and the right-eye pixels 4 (for instance, the left-eye pixels 3 and the right-eye pixels 4 are subjected to charging and discharging alternately), and hence the objective of reducing the crosstalk in the applications of the active shutter 3D LCD display can be achieved.

One example of the timing controller 1 includes a single chip microcomputer 11, a PCB 12 and a plurality of circuit channels 5, and the single chip microcomputer 11 may also be replaced by a microprocessor such as a central processing unit (CPU) or a dedicated electronic device such as a digital signal processor (DSP). The single chip microcomputer 11 is connected with the PCB 12 having the function as an interface circuit, and the PCB 12 is respectively connected with the left-eye pixels 3 and the right-eye pixels 4 on the array substrate through the plurality of the circuit channels 5 and the gate electrode driving unit 21 or the data driving unit 22. The single chip microcomputer 11 can control the display timing of the left-eye pixels 3 and the right-eye pixels 4 by controlling circuit signals outputted by the PCB 12 according to the preset programs. The PCB has the characteristics of small size, stable operation and the like. It is important that the PCB has expandability and hence is easy to upgrade the timing controller.

The layout structures of the pixels of the display panel have many types, including linear type, mosaic type, triangular type and the like. Description will be given below to the embodiment by taking the layout structure of the pixels of the linear type as an example.

### Embodiment 1

For instance, in an LCD device provided by the embodiment as illustrated in FIG. 3, an array substrate of the display device includes transversely extending gate lines 7 and longitudinally extending data lines 6; a plurality of pixels are defined by the intercrossing of the gate lines 7 and the data lines 6, and include left-eye pixels 3 (represented by L) and right-eye pixels 4 (represented by R); both the left-eye pixels 3 and the right-eye pixels are arranged in columns; and left-eye pixel columns and right-eye pixel columns are alternately arranged.

A timing controller 1 is respectively connected with the data lines 6, corresponding to the left-eye pixel columns and the right-eye pixel columns, through a data driving unit 22, and configured to respectively control the display timing of the left-eye pixels 3 and the right-eye pixels 4, and hence can accurately control the charging and discharging of the left-eye pixels 3 and the right-eye pixels 4, and consequently the display effect of a 3D display can be guaranteed. In the embodiment, it may be not required that the timing controller 1 is connected with the gate lines on the array substrate through a gate electrode driving unit 21.

More specifically, in one example, the gate electrode driving unit 21 achieves the display function by the progressive or interlaced scanning of all the gate lines in a display cycle; and the display panel may display a left-eye image at first and then display a right-eye image. When the left-eye image is to be displayed, under the control of the timing controller 1, the data driving unit 22 outputs display data to the left-eye pixels 3 in a pixel row and outputs BFI data to the right-eye pixels 4 in the pixel row. After one image frame is completely scanned by the gate electrode driving unit 21, one frame of the left-eye image is displayed by all the left-eye pixels as a whole on the display panel, and an all-black frame is displayed by all the right-eye pixels 4 as a whole. Correspondingly, when the right-eye image is displayed, under the control of the timing controller 1, the data driving unit 22 outputs display data to the right-eye pixels 4 in a pixel row and outputs BFI data to the left-eye data 3 in the pixel row. After one image frame is completely scanned by the gate electrode driving unit 21, an all-black frame is displayed by all the left-eye pixels 3 as whole on the display panel, and one frame of the right-eye image is displayed by all the right-eye pixels 4 as a whole. Detailed description about the “BFI” technology will be given below.

### Embodiment 2

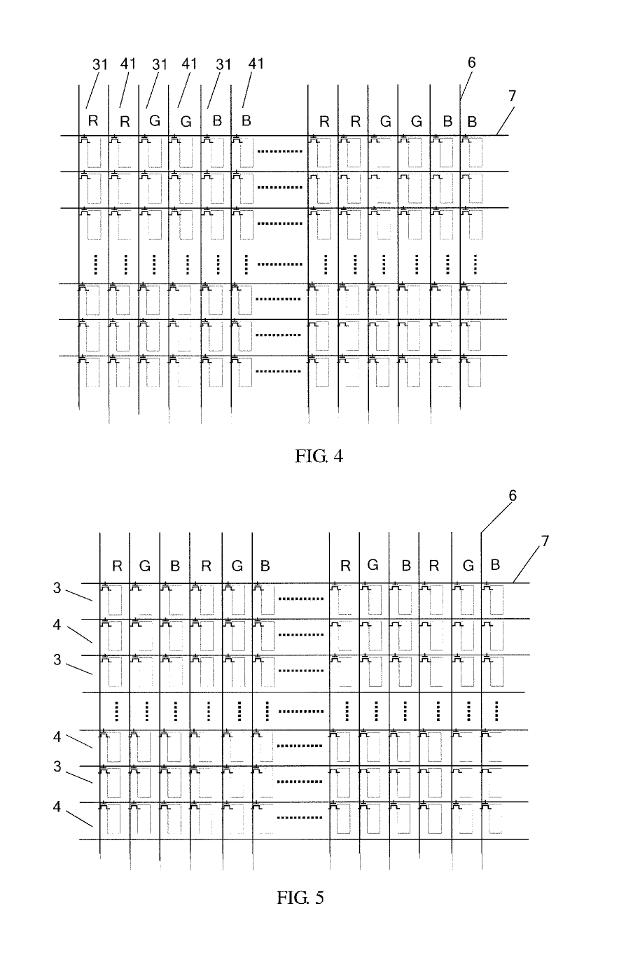

Or as illustrated in FIG. 4, in the embodiment, the left-eye pixels 3 include a plurality of columns of left-eye sub-pixels 31, and the right-eye pixels 4 include a plurality of columns of right-eye sub-pixels 41; and the left-eye sub-pixels 31 and the right-eye sub-pixels 41 are alternately arranged. The timing controller 1 is respectively connected with the data lines 6, corresponding to the left-eye sub-pixels 31 and the right-eye sub-pixels 41, through a data driving unit 22, and configured to respectively control the display timing of the left-eye sub-pixels 31 and the right-eye sub-pixels 41, and hence can accurately control the charging and discharging of each column of color pixels, and consequently the display effect of the 3D display can be guaranteed.

Moreover, a sub-pixel group is formed of one column of left-eye sub-pixels 31 and one column of right-eye sub-pixels 41, which columns are adjacent to each other; color filters corresponding to the left-eye sub-pixels 31 and the right-eye sub-pixels 41 in a same sub-pixel group have different colors (and thus light emitted in display has different colors); or as illustrated in FIG. 4, the color filters corresponding to the left-eye sub-pixels 31 and the right-eye sub-pixels 41 in a same sub-pixel group have a same color, and color filters corresponding to two adjacent sub-pixel groups have different colors.

The display mode of the display panel in the embodiment 2 is similar to that in the embodiment 1. Therefore, no further description will be given here.

In the display panel structure of the above-described embodiments, the array substrate may also adopt the structure of transversely extending data lines and longitudinally extending gate lines. In this case, the timing controller can also be respectively connected with the data lines, corresponding to each longitudinal column of pixel units on the array substrate, through the PCB, and is configured to control the drive timing of the left-eye pixels and the right-eye pixels.

### Embodiment 3

In a plurality of pixel units defined by gate lines 7 and data lines 6 on an array substrate provided by another embodiment, as illustrated in FIG. 5, both left-eye pixels 3 and right-eye pixels 4 may be arranged in rows; and the left-eye pixels 3 and the right-eye pixels 4 are alternately arranged. A timing controller 1 is respectively connected with the gate lines 7, corresponding to the left-eye pixel rows and the right-eye pixel rows on the array substrate, through a gate electrode driving unit 21, and configured to respectively control the display timing of the left-eye pixels 3 and the right-eye pixels 4. In the embodiment, it may be not required that the timing controller 1 is connected with the data lines on the array substrate through a data driving unit 22.

More specifically, in one example, the display panel can display a left-eye image at first and hence display a right-eye image in a display cycle. When the left-eye image is displayed, under the control of the timing controller 1, the gate electrode driving unit 21 performs progressive scanning. When left-eye pixel rows are scanned, the data driving unit 22 outputs display data to the left-eye pixels 3; and when right-eye pixel rows are scanned, the data driving unit 22 outputs BFI data to the right-eye pixels 4. After one image frame is completely scanned by the gate electrode driving unit 21, one frame of the left-eye image is displayed by all the left-eye pixels 3 as a whole on the display panel, and an all-black frame is displayed as a whole by all the right-eye pixels 4. When the right-eye image is displayed, the gate electrode driving unit 21 performs progressive scanning. When the left-eye pixel rows are scanned, the data driving unit 22 outputs BFI data to the left-eye pixels 3; and when the right-eye pixel rows are scanned, the data driving unit 22 outputs display data to the right-eye pixels 4. After one image frame is completely scanned by the gate electrode driving unit 21, an all-black frame is displayed as a whole by all the left-eye pixels 3 on the display panel, and one frame of the right-eye image is displayed as a whole by all the right-eye pixels 4. Detailed description about the “BFI” technology will be given below.

In another example, the display panel can display the left-eye image at first and then display the right-eye image in a display cycle. When the left-eye image is displayed, under the control of the timing controller 1, the gate electrode driving unit 21 performs interlaced scanning, namely only scans left-eye pixel rows, and the data driving unit 22 outputs display data to the left-eye pixels 3. When the right-eye image is displayed, under the control of the timing controller 1, the gate electrode driving unit 21 performs interlaced scanning, namely only scans right-eye pixel rows, and the data driving unit 22 outputs display data to the right-eye pixels 4.

### Embodiment 4

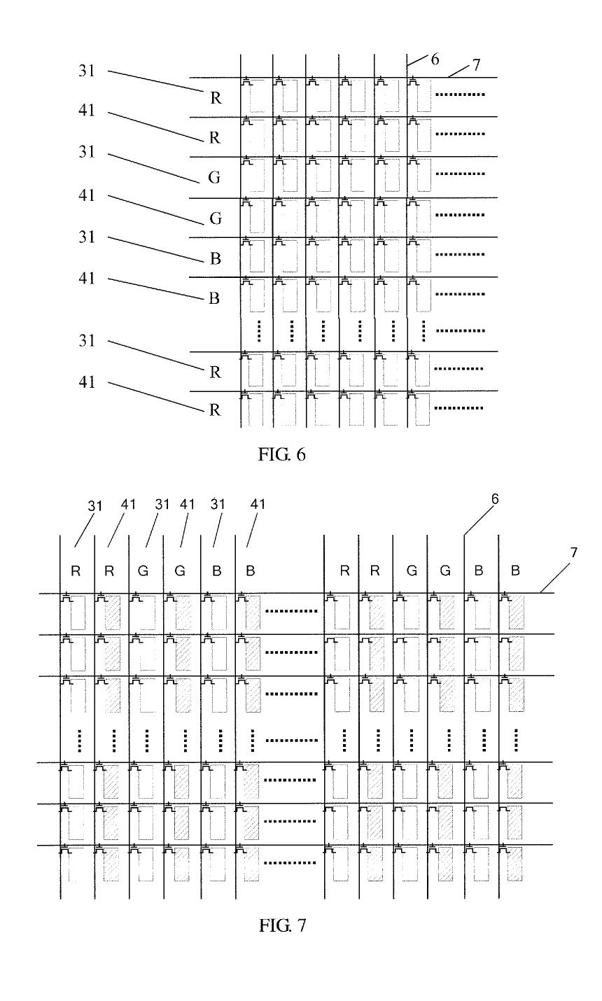

Or as illustrated in FIG. 6, the left-eye pixels 3 include a plurality of rows of left-eye sub-pixels 31, and the right-eye pixel 4 include a plurality of rows of right-eye sub-pixels 41; the left-eye sub-pixels 31 and the right-eye sub-pixels 41 are alternately arranged; and the timing controller 1 is respectively connected with the gate lines 7, corresponding to the left-eye sub-pixels 31 and the right-eye sub-pixels 41 on the array substrate, through the gate electrode driving unit 21, and configured to respectively control the display timing of the left-eye sub-pixels 31 and the right-eye sub-pixels 41. The display mode of the display panel is similar to that of the above example. No further description will be given here.

Preferably, a sub-pixel group is formed by one row of left-eye sub-pixels 31 and one row of right-eye sub-pixels 41, which rows are adjacent to each other; and color filters corresponding to the left-eye sub-pixels 31 and the right-eye sub-pixels 41 in a same sub-pixel group have different colors; or as illustrated in FIG. 6, the color filters corresponding to the left-eye sub-pixels 31 and the right-eye sub-pixels 41 in a same sub-pixel group have same color, and color filters corresponding to two adjacent sub-pixel groups have different colors.

The display mode of the display panel in the embodiment 4 is similar to that in the embodiment 3. Therefore, no further description will be given here.

### Embodiment 5

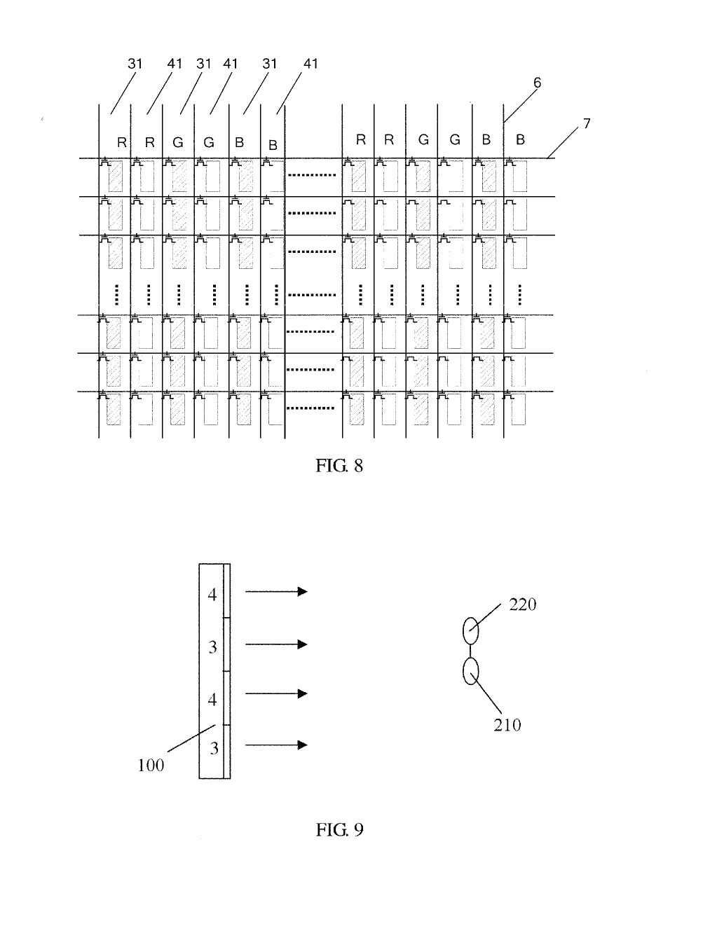

Another embodiment of the present invention further provides a 3D LCD system, for instance, an active shutter 3D LCD system. As illustrated in FIG. 9, the 3D LCD system comprises the 3D LCD device 100 according to any one of the above embodiments, and a pair of 3D glasses. The 3D glasses can be worn by a viewer to view images displayed by the display device, and includes a left-eye lens 210 and a right-eye lens 220. The 3D LCD device 100 cooperates with the 3D glasses, so that the left-eye lens 210 of the 3D glasses is switched on while the right-eye lens 220 is switched off when left-eye images are displayed by the left-eye pixels 3 of the display device as a whole; and the right-eye lens 220 of the 3D glasses is switched on while the left-eye lens 210 is switched off when right-eye images are displayed by the right-eye pixels 4 of the display device as a whole.

The 3D glasses includes a switch device to control the switching between the left-eye lens and the right-eye lens. The operation of the switch device with respect to the left-eye lens and the right-eye lens is synchronous with the operation of the timing controller in the display device with respect to the left-eye pixels and the right-eye pixels, or the switch device may be directly controlled by the timing controller of the display device to perform corresponding operations. The switch device is, for instance, synchronous or connected with the timing controller by a wireless means.

### Embodiment 6

In addition, the embodiment further provides a driving method for achieving 3D image display by adoption of the 3D LCD system. The method comprises the following steps.

Performing BFI with respect to right-eye pixels 4 (namely all the right-eye sub-pixels 41) of an LCD device, and meanwhile controlling a left-eye lens of a pair of 3D glasses to switch on and a right-eye lens to switch off, when a left-eye image is displayed by left-eye pixels 3 (namely all the left-eye sub-pixels 31) of the LCD device, as illustrated in FIG. 7.

Performing BFI with respect to the left-eye pixels 3 (namely all the left-eye sub-pixels 31) of the LCD device, and meanwhile controlling the right-eye lens of the 3D glasses to switch on and the left-eye lens to be switch off, when a right-eye image is displayed by the right-eye pixels 4 (namely all the right-eye sub-pixels 41) of the LCD device, as illustrated in FIG. 8.

The “BFI” technology is to insert an all-black frame between two adjacent frames or a plurality of adjacent frame to achieve the effect of increasing the total frame number. In the driving method of the embodiment, at any moment of the display process, if a left-eye image is displayed by the left-eye pixels of the display device, an all-black frame is displayed by the right-eye pixels; otherwise, if a right-eye image is displayed by the right-eye pixels of the display device, an all-black frame is displayed by the left-eye pixels. Therefore, the crosstalk in display of the active shutter 3D LCD device can be eliminated.

An embodiments of the present invention have the advantages:

1. The embodiment of the present invention provides a new pixel arrangement structure, achieves the alternate charging and discharging of the left-eye pixels and the right-eye pixels, and hence achieves the objective of reducing the crosstalk in of display when applied to an active shutter 3D LCD device.

2. The embodiment of the present invention is convenient to use; and both the left-eye pixels and the right-eye pixels of the 3D LCD device can achieve dynamic response rapidly, and hence the 3D display effect can be improved.

The foregoing is only the preferred embodiments of the present invention and not intended to limit the scope of protection of the present invention. The scope of protection of the present invention should be defined by the appended claims.

1. A three-dimensional (3D) liquid crystal display (LCD) device, comprising a display panel and a timing controller, wherein the display panel includes an array substrate; the array substrate includes a plurality of pixel units defined by gate lines and data lines which are horizontally and vertically intersected; a plurality of the pixel units include left-eye pixels configured to display a left-eye image and right-eye pixels configured to display a right-eye image; and
the timing controller is connected with the array substrate and configured to respectively control the display timing of the left-eye pixels and the right-eye pixels,

2. The 3D LCD device according to claim 1, further comprising: a driving unit; and the timing controller is respectively connected with the left-eye pixels and the right-eye pixels on the array substrate through the driving unit.

3. The 3D LCD device according to claim 2, wherein both the left-eye pixels and the right-eye pixels are arranged in columns; left-eye pixel columns and right-eye pixel columns are alternately arranged; the driving unit includes a data driving unit; and
the timing controller is respectively connected with the data lines, corresponding to the left-eye pixel columns and the right-eye pixel columns on the array substrate, through the data driving unit, and configured to respectively control the display timing of the left-eye pixels and the right-eye pixels

4. The 3D LCD device according to claim 2, wherein the left-eye pixels include a plurality of columns of left-eye sub-pixels, and the right-eye pixels include a plurality of columns of right-eye sub-pixels; the left-eye sub-pixels and the right-eye sub-pixels are alternately arranged; the driving unit includes a data driving unit; and
the timing controller is respectively connected with the data lines, corresponding to the left-eye sub-pixels and the right-eye sub-pixels on the array substrate, through the data driving unit, and configured to respectively control the display timing of the left-eye sub-pixels and the right-eye sub-pixels.

5. The 3D LCD device according to claim 4, wherein a sub-pixel group is formed by one column of the left-eye sub-pixels and one column of the right-eye sub-pixels, which columns are adjacent to each other; and
color filters corresponding to the left-eye sub-pixels and the right-eye sub-pixels in a same sub-pixel group have different colors, or the color filters corresponding to the left-eye sub-pixels and the right-eye sub-pixels in a same sub-pixel group have same color and color filters corresponding to two adjacent sub-pixel groups have different colors.

6. The 3D LCD device according to claim 2, wherein both the left-eye pixels and the right-eye pixels are arranged in rows; left-eye pixel rows and right-eye pixel rows are alternately arranged; the driving unit includes a gate electrode driving unit; and
the timing controller is respectively connected with the gate lines, corresponding to the left-eye pixel rows and the right-eye pixel rows on the array substrate, through the gate electrode driving unit, and configured to respectively control the display timing of the left-eye pixels and the right-eye pixels.

7. The 3D LCD device according to claim 2, wherein the left-eye pixels include a plurality of rows of left-eye sub-pixels, and the right-eye pixels include a plurality of rows of right-eye sub-pixels; the left-eye sub-pixels and the right-eye sub-pixels are alternately arranged; the driving unit includes a gate electrode driving unit; and
the timing controller is respectively connected with the gate lines, corresponding to the left-eye sub-pixels and the right-eye sub-pixels on the array substrate, through the gate electrode driving unit, and configured to respectively control the display timing of the left-eye sub-pixels and the right-eye sub-pixels.

8. The 3D LCD device according to claim 7, wherein a sub-pixel group is formed by one row of the left-eye sub-pixels and one row of the right-eye sub-pixels, which rows are adjacent to each other; and
color filters corresponding to the left-eye sub-pixels and the right-eye sub-pixels in the same sub-pixel group have different colors, or the color filters corresponding to the left-eye sub-pixels and the right-eye sub-pixels in the same sub-pixel group have same color and color filters corresponding to two adjacent sub-pixel groups have different colors.

9. A 3D LCD system, comprising the 3D LCD device according to claim 1, and a pair of 3D glasses.

10. A driving method for achieving 3D image display by adoption of the 3D LCD system according to claim 9, comprising:
performing black frame insertion (BFI) with respect to the right-eye pixels of the LCD device and meanwhile controlling a left-eye lens of the 3D glasses to switch on and a right-eye lens to switch off, upon a left-eye image being displayed by left-eye pixels of the LCD device; and
performing BFI with respect to the left-eye pixels of the LCD device and meanwhile controlling the right-eye lens of the 3D glasses to switch on and the left-eye lens to switch off, upon a right-eye image being displayed by the right-eye pixels of the LCD device.
